(19) United States
(12) Patent Application Publication
(10) Pub. No.: US 2019/0043063 A1
(43) Pub. Date: Feb. 7, 2019

(54) MODEL-BASED ASSESSMENT AND IMPROVEMENT OF RELATIONSHIPS

(71) Applicant: LinkedIn Corporation, Sunnyvale, CA (US)

(72) Inventors: Mads Johnsen, San Jose, CA (US); Jason C. Phan, San Francisco, CA (US); Ronak Shah, San Francisco, CA (US); Wei Ling Heng, San Francisco, CA (US); Jessie Tang, San Jose, CA (US); Gloria Yang, San Francisco, CA (US)

(73) Assignee: LinkedIn Corporation, Sunnyvale, CA (US)

(21) Appl. No.: 15/670,862

(22) Filed: Aug. 7, 2017

(51) Int. Cl. G06Q 30/02; G06Q 50/00; H04L 29/08; G06F 17/30

(52) U.S. Cl. CPC G06Q 30/0201; G06F 17/30554; H04L 67/306; G06Q 50/01

(57) ABSTRACT

The disclosed embodiments provide a system for processing data. During operation, the system obtains an engagement metric correlated with successful usage of a product by a set of customers. Next, the system identifies a threshold for the engagement metric that represents a change in customer growth for the product. The system then uses the threshold and a value of the engagement metric for a customer to characterize a revenue quality of a customer with the product. Finally, the system outputs the revenue quality and the value of the engagement metric for use in managing interaction with the customer.

### BACKGROUND

### Field

The disclosed embodiments relate to techniques for performing model-based assessment and improvement of relationships.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales and marketing strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

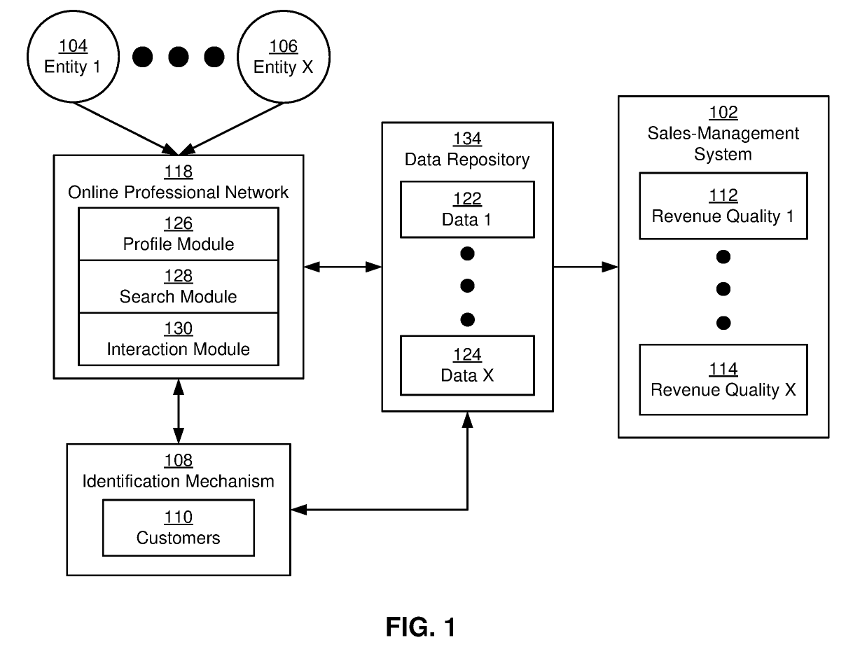

The disclosed embodiments provide a method, apparatus, and system for processing data. More specifically, the disclosed embodiments provide a method, apparatus, and system for performing model-based segmentation of customers in a social network by lifetime values. As shown in FIG. 1, the social network may be an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing profile pictures, along with information related to the entities' professional and/or industry backgrounds, experiences, summaries, projects, and/or skills. Profile module 126 may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities. Interaction module 130 may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, online professional network 118 may include a homepage, landing page, and/or newsfeed that provides the latest postings, articles, and/or updates from the entities' connections and/or groups to the entities. Similarly, online professional network 118 may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, endorsement, invitation, follow, post, comment, like, share, search, click, message, interaction with a group, address book interaction, response to a recommendation, purchase, and/or other action performed by an entity in the online professional network may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on the online professional network and/or sales accounts with sales professionals that operate through online professional network 118. As a result, customers 110 may use online professional network 118 to interact with professional connections, list and apply for jobs, establish professional brands, purchase or use products offered through the online professional network, advertise, and/or conduct other activities in a professional and/or business context.

Customers 110 may also be targeted for marketing or sales activities by other entities in online professional network 118. For example, the customers may be companies that purchase business products and/or solutions that are offered by the online professional network to achieve goals related to hiring, marketing, advertising, and/or selling. In another example, the customers may be individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify customers 110 by matching profile data, group memberships, industries, skills, customer relationship data, and/or other data for customers 110 to keywords related to products that may be of interest to customers 110. Identification mechanism 108 may also identify customers 110 as individuals and/or companies that have sales accounts with online professional network 118 and/or products offered by or through online professional network 118. As a result, customers 110 may include entities that have purchased products through and/or within online professional network 118, as well as entities that have not yet purchased but may be interested in products offered through and/or within online professional network 118.

Identification mechanism 108 may also match customers 110 to products using different sets of criteria. For example, identification mechanism 108 may match customers 110 in recruiting roles to recruiting solutions, customers 110 in sales roles to sales solutions, customers 110 in marketing roles to marketing solutions, and customers 110 in advertising roles to advertising solutions. If different variations of a solution are available, identification mechanism 108 may also identify the variation that may be most relevant to a customer based on the size, location, industry, and/or other attributes of the customer. In another example, products offered by other entities through online professional network 118 may be matched to current and/or prospective customers 110 through criteria specified by the other entities. In a third example, customers 110 may include all entities in online professional network 118, which may be targeted with products such as “premium” subscriptions or memberships with online professional network 118.

After customers 110 are identified, they may be targeted by one or more sales professionals with relevant products. For example, the sales professionals may engage customers 110 with recruiting, marketing, sales, and/or advertising solutions that may be of interest to the customers. After a sales deal is closed with a given customer, a sales professional may follow up with the customer to improve the customer lifetime value (CLV) and retention of the customer. On the other hand, the customer may fail to renew the sales deal or renew at a lower amount if the customer fails to obtain adequate value from the product and/or feels that the renewal price is too high. In other words, the customer may churn from the product if the sales professional is unable to communicate or increase the value of the product to the customer.

In one or more embodiments, the system of FIG. 1 includes functionality to assess and improve the value of products purchased by customers 110 through online professional network 118. More specifically, a sales-management system 102 may use data from data repository 134 to characterize the revenue quality (e.g., revenue quality 1 112, revenue quality x 114) associated with customers 110 of various products. The revenue quality may represent an assessment of revenue from the customer in terms of value delivered by a product to the customer. Thus, a customer with high revenue quality may receive significant value from a product, and a customer with low revenue quality may receive little to no value from a product.

As described in further detail below, sales-management system 102 may use a statistical model to identify an engagement metric that correlates with successful usage of a product. Sales-management system 102 may then use one or more thresholds associated with the engagement metric to characterize the revenue quality associated with each customer of the product. In turn, the revenue quality may be outputted with one or more recommended actions to improve the value of the product for the customers and/or subsequent revenue growth associated with the customers.

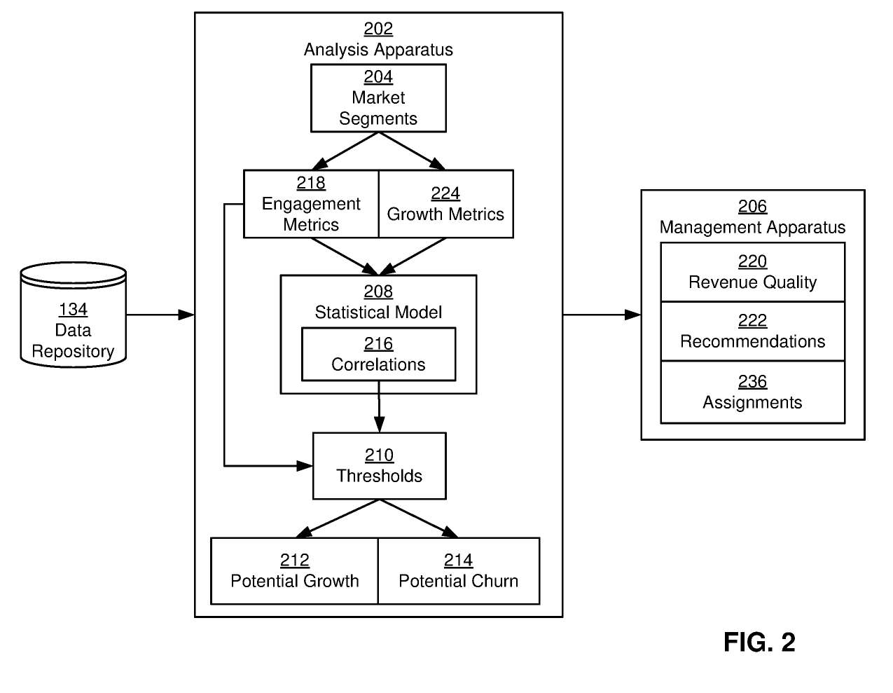

FIG. 2 shows a system for processing data in accordance with the disclosed embodiments. More specifically, FIG. 2 shows a system for evaluating and improving revenue quality for a set of customers, such as sales-management system 102 of FIG. 1. As shown in FIG. 2, the system includes an analysis apparatus 202 and a management apparatus 206. Each of these components is described in further detail below.

Analysis apparatus 202 may generate and/or determine a revenue quality 220 for customers of one or more products, such as companies that have bookings and/or accounts with products offered by or through a social network or online professional network (e.g., online professional network 118 of FIG. 1). As mentioned above, revenue quality 220 may be a measure and/or classification of the revenue obtained from a customer for a product in terms of the value delivered to the customer by the product.

Revenue quality 220 may be assessed for various market segments 204 associated with each product. Each market segment may represent a group of customers that share one or more common attributes. For example, market segments 204 in an online professional network may include members and/or companies with the same industry, role (e.g., advertising, recruiting, learning and development, sales, marketing, business development, management, engineering, creative, etc.), location (e.g., city, state, region, country, etc.), company type (e.g., corporate, staffing, etc.), company size or account tier (e.g., small business, medium/enterprise, global/large, number of employees, market cap, etc.), acquisition channel (e.g., field, online, email, etc.), age, level of seniority, level of spending, historic spending, brand reputation, popularity, and/or language. In turn, the customers may be targeted and/or reached based on shared needs, preferences, behavior, interests, lifestyles, and/or demographic attributes in the corresponding market segments 204. As a result, attributes common to members in a given market segment may be selected based on the relevance of the attributes to features of the online professional network and/or products offered by or through the online professional network.

Customers in a given market segment may be identified using attributes related to job titles, industries, profile attributes, historic spending, and/or activity related to the market segment. Data used to place a customer in a market segment may thus be obtained from the customer's profile with the online professional network. The data may also, or instead, be obtained from a customer relationship management (CRM) account for the customer and/or public records for the customer.

For customers in each market segment, analysis apparatus 202 may obtain a number of engagement metrics 218 and growth metrics 224. Engagement metrics 218 may reflect the customers' usage of the product and/or the value derived from the product by the customers. For example, each engagement metric may include a cost per action associated with successful usage of the product. As a result, engagement metrics 218 for a recruiting solution may include, but are not limited to, the effective cost of an application for a job listing, acceptance of a message from a recruiter, a page view on a company page, and/or a thousand page views on a job slot before a hire is made through the recruiting solution. The cost per action may be calculated based on the price paid for use of the product and the number of actions performed per successful use of the product. Thus, if a customer pays $100 a month for a recruiter seat and confirms a hire after an average of 10 messages from the recruiter seat are accepted by job candidates over a given month, the customer may effectively pay $10 per accepted message through the recruiter seat for each successful hire made that month.

In general, engagement metrics 218 may represent numbers, costs, and/or other measurements associated with actions or attributes that are correlated with outcomes representing successful or unsuccessful use of the product. For example, engagement metrics 218 for use of an advertising solution by a set of customers may include the number of impressions and/or clicks of an advertisement required to generate a conversion. The number of impressions and/or clicks may optionally be combined with the cost per impression and/or cost per click to obtain the cost per impression or click associated with a successful conversion. In another example, engagement metrics 218 may include combinations of actions and/or attributes that are linked to successful outcomes, such as a referral to a company's job listing combined with a first-degree connection to an employee of the company that leads to a higher chance of being hired for the listed job.

Growth metrics 224 may represent the historic growth of the customers' accounts. For example, growth metrics 224 may include an existing account growth that tracks the growth or churn rate of a set of customers in a given market segment for a product. The growth or churn rate may be calculated as the year-over-year percentage increase or decrease in customer bookings for the product. Growth metrics 224 may also, or instead, include other measures of customer growth or churn, such as year-over-year changes in the amount spent by the customers.

Analysis apparatus 202 may apply a statistical model 208 to engagement metrics 218 and growth metrics 224 to determine a set of correlations 216 between engagement metrics 218 and growth metrics 224. For example, analysis apparatus 202 may fit a logistic regression model to a number of independent engagement metrics 218 and a dependent binary outcome representing growth or churn of a customer that is determined using growth metrics 224. Coefficients of the logistic regression model may represent correlations 216 between engagement metrics 218 and the outcome. For example, an engagement metric with a higher regression coefficient may be more highly correlated with the outcome than an engagement metric with a lower regression coefficient.

In turn, analysis apparatus 202 may use correlations 216 to select one or more engagement metrics 218 for use in characterizing revenue quality 220 for customers of a given product and/or market segment. Continuing with the previous example, analysis apparatus 202 may select one engagement metric as the independent variable with the highest regression coefficient in the logistic regression model. Alternatively, analysis apparatus 202 may use statistical model 208 and/or correlations 216 to select multiple engagement metrics 218 that are highly correlated with growth metrics 224 for the product and/or market segment.

Next, analysis apparatus 202 may determine thresholds 210 in the selected engagement metrics 218 that represent a change in growth metrics 224 and/or a change in the outcome reflected in growth metrics 224. For example, analysis apparatus 202 may plot a regression line that is fit to values of the selected engagement metric and values of an existing account growth for customers associated with a given product and/or market segment. Analysis apparatus 202 may use the regression line to identify a threshold for the engagement metric as a value of the engagement metric that represents a flat customer account (i.e., neither growth nor churn in the account).

Thus, values of the engagement metric that fall on one side of the threshold (e.g., values that are lower than the threshold) may indicate potential growth 212 for the corresponding customers. On the other hand, values of the engagement metric that fall on the other side of the threshold (e.g., values that are higher than the threshold) may indicate potential churn 214 for the corresponding customers. For example, a threshold for a cost per job application through a job listing service may be set to $7 per job application. A customer that pays less than $7 per job application to hire a candidate may receive high value from the job listing service, and in turn, may be more likely to increase spending with the job listing service. Conversely, a customer that pays more than $7 per job application to hire a candidate may receive less value from the job listing service and be at greater risk of fully or partially churning from the job listing service (e.g., by terminating or not renewing a contract or subscription with the job listing service).

In turn, analysis apparatus 202 may characterize revenue quality 220 for each market segment by comparing the value of the selected engagement metric for each customer in the market segment with a threshold representing flat account growth in the market segment. Customers with engagement metric values that fall below the threshold (e.g., lower costs per action) may be associated with revenue quality 220 that leads to potential growth 212, while customers with engagement metric values that are higher than the threshold (e.g., higher costs per action) may be associated with revenue quality 220 that leads to potential churn 214.

Analysis apparatus 202 may optionally use multiple thresholds 210 for engagement metrics 218 to perform finer-grained classification of revenue quality 220 for a given market segment and/or product. For example, analysis apparatus 202 may identify two additional thresholds in a “cost per page view” engagement metric beyond the threshold that represents the boundary between potential growth 212 and potential churn 214.

One threshold may characterize different degrees of potential growth 212 using a boundary between potential growth 212 and potential churn 214 for a comparable product from a competitor. In this example, the threshold between potential growth 212 and potential churn 214 in customers of a “company page” product may be set to $5 per page view, and a separate threshold between potential growth 212 and potential churn 214 in customers of a competitor's company page product may be set to $4 per page view. As a result, a customer may have revenue quality 220 that exceeds competition when the customer's cost per page view for hiring candidates using the company page product is lower than the $4 per page view to hire candidates using the competitor's product. The customer may have revenue quality 220 that represents potential growth 212 that does not exceed competition when the customer's cost per page view is between the $4 per page view for hiring using the competitor's product and the $5 per page view for hiring using the product.

Another threshold may characterize different degrees of potential churn 214 using a boundary between lower revenue quality 220 and significant likelihood of churning. Continuing with the cost per page view metric for the company page product, the threshold may be set to a $10 cost per page view that represents a given customer churn rate (e.g., 25%, 50%, etc.). The threshold may also, or instead, include a certain number of months in the last year in which low revenue quality 220 is experienced (e.g., a cost per page view that exceeds the $5 threshold or $10 threshold for six months out of the last year). The threshold may also, or instead, be based on metrics that identify the customer's level of activity with the company page product. Consequently, the customer may have lower revenue quality 220 when the customer's cost per page view is between the $5 threshold between potential growth 212 and potential churn 214 and the $10 threshold for high churn rate. The customer may have revenue quality 220 that represents significant likelihood of churning when the customer's cost per page view exceeds one or both thresholds for six months or more out of the last year and/or has little to no activity with the product.

Management apparatus 206 may display information associated with revenue quality 220, engagement metrics 218, and/or growth metrics 224. For example, management apparatus 206 may provide a graphical user interface (GUI) for use in analyzing and/or managing revenue quality 220 by management and/or sales representatives. Within the GUI, management apparatus 206 may display a table, chart, ranking, and/or other representation of revenue quality 220, engagement metrics 218, and/or growth metrics 224 for various customers, products, and/or market segments 204. Management apparatus 206 may also display filters for values and/or ranges of values for engagement metrics 218, growth metrics 224, revenue quality 220, market segments 204, customer names, product names, product types, renewal dates, and/or other attributes associated with the customers or products. After one or more filters are selected through the GUI, management apparatus 206 may update the displayed data to reflect the filter(s).

As a result, management apparatus 206 may allow trends and/or patterns associated with revenue quality 220 to be identified for various customers, market segments 204, and/or products. For example, data provided by management apparatus 206 may indicate an issue with a product when most or all customers of the product have low revenue quality 220. Conversely, the data may indicate an issue with a customer when the customer has low revenue quality 220 with a product but similar customers (e.g., customers in the same market segment) have high revenue quality 220 with the same product.

Management apparatus 206 may also generate a set of recommendations 222 associated with revenue quality 220, engagement metrics 218, and/or growth metrics 224. First, management apparatus 206 may identify and/or flag customers that behave irrationally by renewing despite receiving low value from the corresponding products and/or not renewing despite receiving high value from the products. Management apparatus 206 and/or another component of the system may suggest a list of factors that may influence or cause such behavior.

Management apparatus 206 may also, or instead, suggest actions and/or alternative products for enacting improvements in revenue quality 220 for customers associated with both potential growth 212 and potential churn 214. For example, management apparatus 206 and/or another component of the system may determine that low revenue quality 220 for a customer of a recruiting solution is caused by a lack of accepted messages from recruiters. To compensate for the low message acceptance rate, the component may recommend increasing advertisement activity for job listings by the customer and/or provide tips for writing messages that increase acceptance by potential candidates. In another example, the component may identify a customer with high revenue quality 220 for a product and suggest increasing the customer's spending with the same product to improve both revenue growth and the product's value to the customer. In a third example, the component may analyze the customer's revenue quality 220 for multiple related products (e.g., products used to hire candidates) and recommend a reallocation of the customer's spending across the products based on the relative value derived from each product. In a fourth example, the component may recommend a discount and/or promotion for a customer that has low revenue quality 220 and/or is otherwise identified as having significant churn risk.

Management apparatus 206 may further generate a set of assignments 236 based on revenue quality 220 and/or recommendations 222. For example, assignments 236 may be made so that customers in different market segments 204 (e.g., industries, sizes, locations, account types, account tiers, etc.) are assigned to sales and/or marketing professionals with expertise in marketing or selling products to those segments and/or identifying customer needs or value within those segments. In another example, assignments 236 may match customers with a certain revenue quality 220 (e.g., potential growth 212, potential churn 214, exceeds competition, significant risk of churn, etc.) for a product with sales and/or marketing professionals that apply techniques specific to that revenue quality 220 to increase the value of the product and/or other products to the customers.

Consequently, the system of FIG. 2 may improve sales and/or marketing of products by allowing sales or marketing activities to be conducted based on revenue quality 220 for different types of customers and/or products. In turn, the system may reduce customer dissatisfaction related to purchasing and using products that produce low revenue quality 220 and increase the value of the products to the customers. In other words, the system of FIG. 2 may improve the use of computer systems in conducting and managing relationships and interaction with customers of products, including automation of computer-based communications with the customers (e.g., transmitting messages containing recommendations, offers, and/or promotions to the customers and/or initiating communication between a customer and a sales representative based on revenue quality 220).

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, market segments 204, engagement metrics 218, growth metrics 224, and/or other customer or product data may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness. Data repository 134 may further include data from external systems, such as CRM and/or sales-management platforms.

Third, statistical model 208 may be implemented using different techniques and/or may be used to determine correlations 216, threshold 210, and/or revenue quality 220 in different ways. For example, statistical model 208 may be implemented using an artificial neural network, support vector machine, clustering technique, regression model, random forest, and/or other type of machine learning technique. Moreover, the same statistical model and/or different statistical models may be used to generate correlations 216, threshold 210, and/or revenue quality 220 for different market segments 204, groups of customers, and/or types of products.

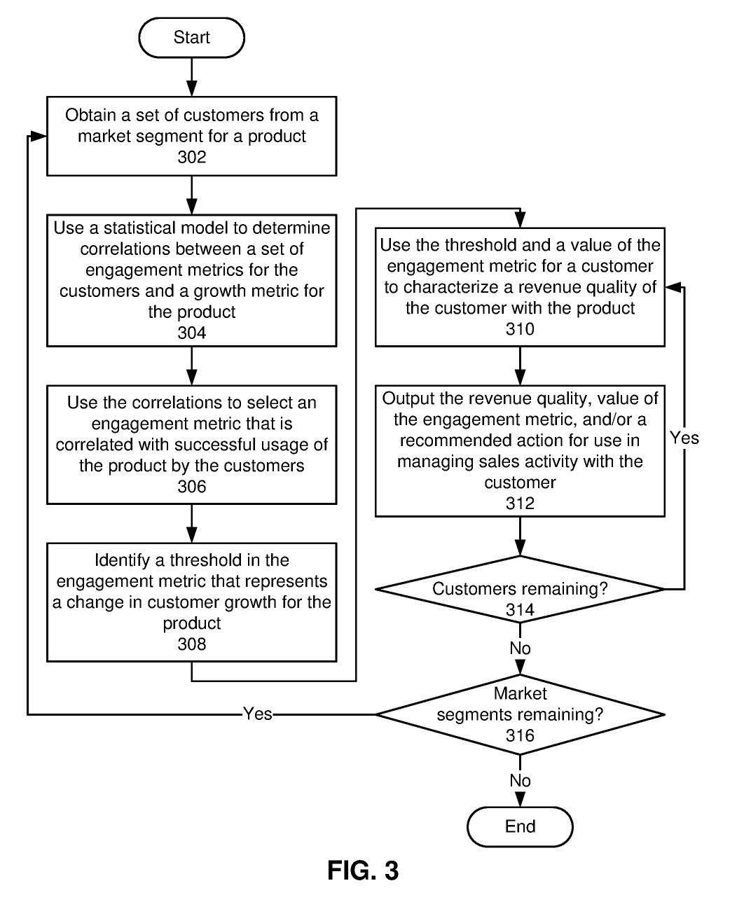

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of customers is obtained from a market segment for a product (operation 302). The market segment may include a company size, location, industry, company type, product type, account tier, acquisition channel, historic spending, and/or other attributes associated with the customers. Next, a statistical model is used to determine correlations between a set of engagement metrics for the customers and a growth metric for the product (operation 304).

Each engagement metric may include a cost per action associated with successful usage of the product. For example, the engagement metric may represent the price paid per acceptance of a message, job application, page view, and/or thousand page views before a successful hire is made using a corresponding recruiting product. The growth metric may indicate an existing account growth or churn rate associated with the customers.

The engagement metrics and growth metrics may be fit to a regression model and/or other type of statistical model, and coefficients and/or other parameters of the statistical model may be used as indicators of correlation between the engagement metrics and the growth metric. Correlations between the engagement metrics and the growth metric are then used to select an engagement metric that is correlated with successful usage of the product by the customers (operation 306). For example, the engagement metric may be selected to have the highest regression coefficient from a regression model that estimates the relationship between a dependent growth metric (e.g., growth rate, binary growth outcome, etc.) and a set of independent engagement metrics.

A threshold in the engagement metric that represents a change in customer growth for the product is also identified (operation 308). For example, the threshold may be a value of the engagement metric that represents a customer with a flat account. As a result, values of the engagement metric that are on different sides of the threshold may represent customer growth or customer churn. In another example, multiple thresholds may be set to identify engagement metric values that represent various amounts of value delivered to the customers by the product.

The threshold and a value of the engagement metric are then used to characterize a revenue quality of the customer with the product (operation 310). For example, the value of the engagement metric may be compared with the threshold to determine if the revenue quality associated with the customer represents exceeding competition, potential growth, lower revenue quality, and/or potential churn. Finally, the revenue quality, value of the engagement metric, and/or a recommended action are outputted for use in managing sales activity with the customer (operation 312). For example, the customer's assessed revenue quality may be compared with the customer's engagement metric to determine if the customer is behaving rationally or irrationally and/or at risk for churn. The customer's behavior and/or churn risk may then be matched to a recommended action to increase the customer's revenue quality and/or the value of the product or other products to the customer. The customer's behavior, churn risk, and recommended action may also be included in a table, spreadsheet, chart, visualization, file, and/or notification to facilitate successful sales and/or marketing activities with the customer.

Operations 310-312 may be repeated for remaining customers (operation 314) in the same market segment. After revenue quality is assessed for all customers in a market segment, operations 302-314 may be repeated for customers in other market segments and/or on a periodic (e.g., monthly) basis. Thus, characterization and improvement of revenue quality may be performed for customers in multiple market segments and/or with multiple products.

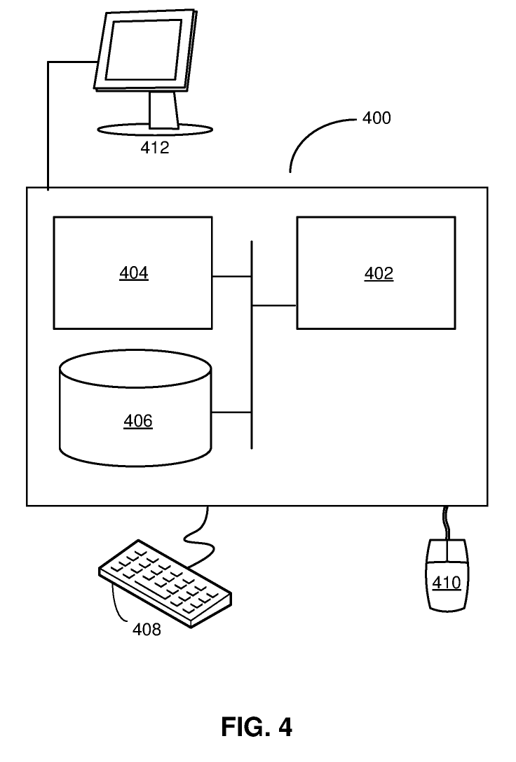

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a management apparatus, one or both of which may alternatively be termed or implemented as a module, mechanism, or other type of system component. The analysis apparatus may obtain an engagement metric correlated with successful usage of a product by a set of customers. Next, the analysis apparatus may identify a threshold for the engagement metric that represents a change in customer growth for the product. The analysis apparatus may then use the threshold and a value of the engagement metric for a customer to characterize a revenue quality of a customer with the product. Finally, the management apparatus may output the revenue quality and the value of the engagement metric for use in managing interaction and/or sales activity with the customer.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that evaluates and improves revenue quality for a set of remote customers of one or more products.

By configuring privacy controls or settings as they desire, members of a social network, online professional network, or other user community that may use or interact with embodiments described herein can control or restrict the information that is collected from them, the information s provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining an engagement metric correlated with successful usage of a product by a set of customers;
identifying, by a computer system, a threshold for the engagement metric that represents a change in customer growth for the product;
using the threshold and a value of the engagement metric for a customer to characterize a revenue quality of a customer with the product; and
outputting the revenue quality and the value of the engagement metric for use in managing interaction with the customer.

2. The method of claim 1, further comprising:
outputting a recommended action for managing sales activity with the customer based on the revenue quality and the value of the engagement metric.

3. The method of claim 1, further comprising:
identifying a correlation between the engagement metric and the successful usage of the product prior to characterizing the revenue quality of the customer with the product.

4. The method of claim 3, wherein identifying the correlation between the engagement metric and the successful usage of the product comprises:
using a statistical model to determine correlations between a set of engagement metrics for the product and a growth metric for the product; and
selecting, from the correlations, the engagement metric that has a highest correlation with the growth metric.

5. The method of claim 4, wherein the statistical model comprises a regression model.

6. The method of claim 4, wherein the growth metric comprises an existing account growth.

7. The method of claim 1, further comprising:
obtaining the set of customers from a market segment for the product.

8. The method of claim 7, wherein the market segment comprises at least one of:
a company size;
a location;
an industry;
a company type;
a product type;
an account tier;
an acquisition channel; and
a historic spending.

9. The method of claim 1, wherein using the threshold to characterize the revenue quality of the customer comprises at least one of:
characterizing the revenue quality based on a comparison of the value of the engagement metric with the threshold.

10. The method of claim 1, wherein the engagement metric comprises a cost per action associated with successful usage of the product.

11. The method of claim 10, wherein the action is at least one of:
acceptance of a message;
a job application;
a page view; and
a thousand page views.

12. The method of claim 1, wherein the revenue quality comprises at least one of:
exceeding competition;
potential growth;
lower revenue quality; and
potential churn.

13. The method of claim 1, wherein the threshold represents a boundary between customer growth and customer churn in the product.

14. An apparatus, comprising:
one or more processors; and
memory storing instructions that, when executed by the one or more processors, cause the apparatus to:
obtain an engagement metric correlated with successful usage of a product by a set of customers;
identify a threshold for the engagement metric that represents a change in customer growth for the product;
use the threshold and a value of the engagement metric for a customer to characterize a revenue quality of a customer with the product; and
output the revenue quality and the value of the engagement metric for use in managing interaction with the customer.

15. The apparatus of claim 14, wherein the memory further stores instructions that, when executed by the one or more processors, cause the apparatus to:
identify a correlation between the engagement metric and the successful usage of the product prior to characterizing the revenue quality of the customer with the product.

16. The apparatus of claim 15, wherein identifying the correlation between the engagement metric and the successful usage of the product comprises:
using a statistical model to determine correlations between a set of engagement metrics for the product and a growth metric for the product; and
selecting, from the correlations, the engagement metric that has a highest correlation with the growth metric.

17. The apparatus of claim 14, wherein the memory further stores instructions that, when executed by the one or more processors, cause the apparatus to:
obtain the set of customers from a market segment for the product.

18. The apparatus of claim 17, wherein the market segment comprises at least one of:
a company size;
a location;
an industry;
a company type;
a product type;
an account tier;
an acquisition channel; and
a historic spending.

19. The apparatus of claim 14, wherein the engagement metric comprises a cost per action associated with successful usage of the product.

20. A non-transitory computer-readable storage medium storing instructions that when executed by a computer cause the computer to perform a method, the method comprising:
obtaining an engagement metric correlated with successful usage of a product by a set of customers;
identifying, by a computer system, a threshold for the engagement metric that represents a change in customer growth for the product;
using the threshold and a value of the engagement metric for a customer to characterize a revenue quality of a customer with the product; and
outputting the revenue quality and the value of the engagement metric for use in managing interaction with the customer.
